(19) United States
(12) Patent Application Publication
(10) Pub. No.: US 2021/0135219 A1
(43) Pub. Date: May 6, 2021

(54) Graphene-Encapsulated Graphene-Supported Phosphorus-Based Anode Active Material for Lithium-Ion or Sodium-ion Batteries

(71) Applicant: Global Graphene Group, Inc., Dayton, OH (US)

(72) Inventors: Aruna Zhamu, Springboro, OH (US); Yu-Sheng Su, Dayton, OH (US); Bor Z. Jang, Centerville, OH (US)

(21) Appl. No.: 16/673,594

(22) Filed: Nov. 4, 2019

(51) Int. Cl. H01M 4/583; H01M 10/054; H01M 4/58; H01M 10/0525; H01M 4/36

(52) U.S. Cl. CPC H01M 4/583; H01M 10/054; H01M 2004/027; H01M 10/0525; H01M 4/366; H01M 4/5805

(57) ABSTRACT

Provided is graphene-encapsulated phosphorus anode particulate for a lithium or sodium ion battery, the particulate comprising: (A) a core comprising one or a plurality of phosphorus material-decorated graphene sheets, wherein the decorated graphene sheets have a length/width from 5 nm to 100 μm and contain single-layer or few-layer graphene and the phosphorus material is in a form of particles or coating having a diameter or thickness from 0.5 nm to 10 μm and is selected from red phosphorus, black phosphorus (including phosphorene), violet phosphorus, a metal phosphide, MP_{y}, or a combination thereof, wherein M=Mn, V, Sn, Ni, Cu, Fe, Co, Zn, Ge, Se, Mo, Ga, In, or an alloy thereof, and y=1-4; and (B) an encapsulating shell that embraces or encapsulates the core, wherein the encapsulating shell comprises multiple graphene sheets and have a thickness from 0.34 nm to 5 μm.

### FIELD

The present disclosure relates generally to the fields of lithium-ion batteries and sodium-ion batteries and, in particular, to a graphene-encapsulated graphene sheet-supported phosphorus (P) particles or coating as an anode active material for a lithium-ion battery or sodium-ion battery.

### BACKGROUND

Next generation lithium-ion batteries (LIBs) are a prime candidate for energy storage devices within aircraft, electric vehicles (EVs), drones, renewable energy storage, and smart grid applications. Graphite materials have been widely used as an anode active material for commercial LIBs due to their relatively low cost and excellent reversibility. However, the theoretical lithium storage capacity of graphite is only 372 mAh/g (based on LiC₆), which limits the total capacity and energy density of a battery. The emerging EV and renewable energy industries demand the availability of rechargeable batteries with a significantly higher energy and power density than what current LIB technology can provide. This requirement has triggered considerable research efforts on the development of electrode materials with higher specific capacity (e.g. Si and P), excellent rate capability, and good cycle stability for LIBs.

Sodium ion batteries (NIBs) have been recognized as the most attractive alternative to the current lithium-ion batteries (LIBs) owing to the natural abundance of sodium. Unfortunately, the low energy density, inferior power density and poor cycle life are still the main issues for NIBs that have prevented NIBs from successful commercialization. The current preferred choice for sodium-ion anode material is hard carbon, which was shown to deliver a specific capacity of 300 mAh/g. The alternative NIB anode materials being considered include Si, Sn, P, and metal oxides/sulfides/selenides.

The primary barriers against more widespread acceptance of battery-powered EVs by consumers are that the EV batteries are still too expensive and too heavy. For instance, a well-known all-electric vehicle manufactured in the US operates on an 85 kilo-watt-hour lithium battery system that can run for 320 miles on one battery charge. However, the battery system weights almost 700 kg, occupies the entire chassis of a car, and costs about $15,000 (battery system alone). This battery cost is equivalent to approximately $175/kWh. The US Department of Energy and industry experts believe that the EV industry cannot be economically viable unless the battery cost goes below $100/kWh. Other worldwide government agencies also mandate that the near-term energy density target of an EV battery must exceed 350 Wh/kg, as opposed to the current 250 Wh/kg.

One potential solution to these two closely related problems of current EV battery cells is to significantly increase the specific capacity (mAh/g) or volumetric energy density (mAh/L) of both the anode and cathode active materials with a minimal increase in cost. As shown in FIG. 1a-1c, the element Si has the highest specific capacity (3,850-4,000 mAh/g) for lithium ion storage; phosphorus (P) has a Li storage capacity of 2500 mAh/g. However, phosphorus (P) can store more Li ions per unit volume (2300 mAh/cm³) vs. 2280 mAh/cm³ of Si. More significantly, P has the highest sodium storage capacity (2596 mAh/g) vs. 950 mAh/g of Si. These theoretical data suggest that P is at least as good as Si as a high-capacity anode material for both LIBs and NIBs.

However, P suffers from several severe problems, including poor first-cycle efficiency, rapid capacity decay, and poor electrode integrity. Presumably, these problems stem from the poor electronic conductivity (1×10⁻¹⁴ S/cm), low Li or Na ion diffusivity and conversion rates, and large volume expansion (about 100%) during cycling. The poor conductivity and low ion diffusivity imply the need for a large amount of conductive additive and poor P utilization efficiency. Repeated volume expansion/shrinkage can lead to repeated formation and destruction of SEI (particularly in a NIB and, hence, continued consumption of Na ions and electrolyte), low Coulomb efficiency, fragmentation of P particles, break-away of P particles from the resin binder, and electrode expansion and delamination. All these phenomena could contribute to fast capacity decay.

Phosphorus (particularly red P and black P in amorphous or crystalline form) is a promising anode material for both LIBs and NIBs owning to its high theoretical specific capacity for storing lithium ions and sodium ions (FIGS. 1(A) & (B)), high volumetric lithium ion storage capacity (FIG. 1(C)) and appropriately low redox potential [1-14]. However, the poor electronic conductivity and large volume expansion of phosphorus during charge/discharge cycling lead to low electrochemical activity (poor P utilization efficiency), poor first-cycle efficiency, fast capacity decay (low Coulomb efficiency), and electrode expansion and delamination, which have thus far limited its practical application.

Graphene, as a two-dimensional carbon material, exhibits high electric and thermal conductivity, high surface area (theoretically 2630 m²/g), high mechanical flexibility and strength, and good chemical compatibility relative to intended electrode materials and electrolyte. These excellent properties may be put to good use to help address the fast decay issues of phosphorus-based anode active materials. The following list of references summarizes prior art efforts to use graphene as a supporting material:

### LIST OF REFERENCES

1. J. X. Song, et al. (D.H. Wang group), Chemically bonded phosphorus/graphene hybrid as a high performance anode for sodium-ion batteries, Nano Lett. 14 (2014) 6329-6335.
2. L. K. Pei, et al. Phosphorus nanoparticles encapsulated in graphene scrolls as a high-performance anode for sodium-ion batteries, ChemElectroChem 2 (2015) 1652-1655.
3. C. Zhang, et al., Amorphous phosphorus/nitrogen-doped graphene paper for ultrastable sodium-ion batteries, Nano Lett. 16 (2016) 2054-2060.
4. Y. H. Liu, et al. Red phosphorus nanodots on reduced graphene oxide as a flexible and ultra-fast anode for sodium-ion batteries, ACS Nano 11 (2017) 5530-5537.
5. X. L. Ding, et al., Phosphorus nanoparticles combined with cubic boron nitride and graphene as stable sodium ion battery anodes, Electrochim. Acta 235 (2017) 150-157.
6. G. H. Lee, et al., A reduced graphene oxide-encapsulated phosphorus/carbon composite as a promising anode material for high-performance sodium-ion batteries, J. Mater. Chem. A 5 (2017) 3683-3690.
7. J. Sun, et al. (Y. Cui group), A phosphorene-graphene hybrid material as a high-capacity anode for sodium-ion batteries, Nat. Nanotechnol. 10 (2015) 980-986.
8. Y. Zhang, et al., An air-stable densely packed phosphorene graphene composite toward advanced lithium storage properties, Adv. Energy Mater. 6 (2016) 1600453.
9. Z. X. Yu, (D.H. Wang group), Phosphorus graphene nanosheet hybrids as lithium-ion anode with exceptional high-temperature cycling stability, Adv. Sci. 2 (2015) 1400020.
10. L. Chen, et al. (H.M. Cheng group), Scalable clean exfoliation of high-quality few-layer black phosphorus for a flexible lithium ion battery, Adv. Mater. 28 (2016) 510-517.
11. Y. Y. Zhang, et al., Wet-chemical processing of phosphorus composite nano sheets for high-rate and High-capacity lithium-ion batteries, Adv. Energy Mater. (2016) 1502409.
12. X. Ma, et al. Phosphorus and Nitrogen Dual-Doped Few-Layered Porous Graphene: A High-Performance Anode Material for Lithium-Ion Batteries. ACS Appl. Mater. Interfaces 2014, 6, 14415-14422.
13. Zishuang Yue, et al., “Utilizing a graphene matrix to overcome the intrinsic limitations of red phosphorus as an anode material in lithium-ion batteries,” Carbon, V. 127, February 2018, P588-595.

However, these prior studies have fallen short in addressing the major issues associated with using phosphorus-based anode active materials for both LIBs and NIBs.

For instance, Wang's team [1] employed graphene to composite with phosphorus by ball-milling as NIB anodes. They claimed that the graphene served to enhance the overall conductivity and buffer the large volume change of phosphorus during cycling. As a result, the phosphorus/graphene composite showed a high initial capacity of 2077 mAh/g (based on P weight, not composite weight) at 260 mA/g and retained 1700 mAh/g after 60 cycles. Some improvement was achieved through partial encapsulation of phosphorus by graphene scrolls [2]. The synthesis was conducted via co-freeze-drying phosphorus nanoparticles and graphene oxide (GO) nano-sheets, followed by a reduction process. The resulting phosphorus-graphene composite anodes for NIBs showed a reversible capacity of 2355 mA h/g (based on the P weight) with high capacity retention of 92.3% after 150 cycles at a current density of 250 mA/g [2]. Unfortunately, the P content in the composite is only 52%, implying that the actual specific capacity of the anode based on the total composite weight is only 1225 mAh/g (composite weight). Zhang et al. [3] redesigned a novel anode structure by fabricating flexible paper made of nitrogen-doped graphene and amorphous phosphorus. The restructured anode exhibited a stable cyclic performance (0.002% decay per cycle from 2nd to 350th cycle at 800 mA/g). However, such a paper-like structure still allows for direct contact of P material with liquid electrolyte and, hence, does not solve the problem of repeated SEI destruction and formation during cycling of sodium-ion batteries.

Phosphorene, namely monolayer or few-layer black phosphorus (BP), has recently attracted great scientific interest for LIBs/NIBs applications. Phosphorene-graphene hybrid, as an anode for NIBs, has achieved exciting progress. The phosphorene-graphene hybrid material, consisting of a few phosphorene layers sandwiched between graphene layers, delivered a specific capacity of 2440 mAh/g(P) at a current density of 50 mA/g with 83% capacity retention after 100 cycles while operating between 0 and 1.5 V [7]. However, there are still some hurdles before phosphorene as anode material can realize commercialization. A cycling life of slightly above 100 cycles is not acceptable to battery industry.

Another hurdle is the poor air stability of phosphorene which plagues its electrochemical activities. In addition, some side effects are inevitably induced on exfoliated phosphorene. Finally, its high specific surface area can lead to low initial Coulombic efficiency and the low packing efficiency of nanostructures results in low volumetric capacity. To deal with these problems, Zhang et al. [8] prepared densely stacked packed phosphorene-graphene composite (PG-SPS, a packing density of 0.6 g/cm3) via spark plasma sintering. When used for LIBs, PG-SPS electrode showed a much improved initial Coulombic efficiency of 60.2% as compared to phosphorene (11.5%) and loosely stacked phosphorene-graphene (34.3%) electrodes.

These previous studies have provided some hints about the roles of graphene in improving the performance of P-based anode materials. However, these earlier approaches have fallen short in solving the problems such as low first-cycle efficiency (11%-61%, meaning at least 39% of the Li or sodium ions originally stored in the cathode is lost after first charge/discharge cycle) and fast capacity decay. We believe that the problem of fast capacity decay in a NIB is caused by repeated formation and destruction of solid-electrolyte interphase (SEI) during charge/discharge cycling. As the volume of the anode active material and the electrode expand and shrink during cycling, the SEI film which is initially formed on anode material surfaces gets broken, and the fresh surface of anode is exposed to electrolyte, eventually consuming additional Na⁺ ions and electrolyte to make new SEI film. This new SEI film is destructed again during the next charge/discharge cycle. These repeated reactions result in low coulombic efficiency and continuing capacity deterioration.

In summary, the prior art has not demonstrated a phosphorus material system that has all or most of the properties desired for use as an anode active material in a lithium-ion battery or sodium-ion battery. Thus, there is an urgent and continuing need for a new anode active material that enables a lithium-ion battery to exhibit a high cycle life, high reversible capacity, low irreversible capacity, small particle sizes (for high-rate capacity), and compatibility with commonly used electrolytes. There is also a need for a method of readily or easily producing such a material in large quantities.

Thus, it is a specific object of the present disclosure to meet these needs and address the issues associated the rapid capacity decay of a lithium-ion or sodium-ion battery containing a phosphorus-based high-capacity anode active material.

### SUMMARY

The present disclosure provides a graphene-encapsulated phosphorus anode particulate (or multiple particulates) for a lithium-ion battery (LIB) or sodium ion battery (NIB), the particulate comprising: (A) a core comprising a phosphorus material and one or a plurality of internal graphene sheets, wherein the internal graphene sheets have a length or width from 5 nm to 100 μm and contain single-layer or few-layer graphene sheets and the phosphorus material is in a form of particles or coating in physical contact with the internal graphene sheets and having a diameter or thickness from 0.5 nm to 10 μm (preferably from 0.5 nm to 1 μm and most desirably from 1 nm to 100 nm) and is selected from red phosphorus, black phosphorus, violet phosphorus, a metal phosphide, MP_{y}, or a combination thereof, wherein M=Mn, V, Sn, Ni, Cu, Fe, Co, Zn, Ge, Se, Mo, Ga, In, or an alloy thereof, and y=1, 2, 3, 4; and (B) an encapsulating shell that embraces or encapsulates the core, wherein the encapsulating shell comprises multiple graphene sheets (herein referred to as exterior graphene sheets) and have a thickness from 0.34 nm to 5 μm. Graphene sheets are present in both the shell and the core of the core-shell structure of these particulates. The proportion of graphene sheets in the entire particulate is typically from 0.01% to 30% by weight, but preferably from 0.1% to 20% and more preferably from 1% to 10% by weight.

The phosphorus material as the anode active material (responsible for storing and releasing sodium ions or lithium ions) is preferably from 30% to 99.9% (more preferably at least 50%, further preferably at least 70%, even more preferably at least 80%, further more preferably at least 90% and most preferably at least 95%) by weight of the total composite particulate weight. The higher the P material proportion, the higher is the specific energy or volumetric energy density of the resulting LIB or NIB.

The core may further comprise a conductive additive, such as a carbon, graphite, or polymer (electron-conducting or ion-conducting polymer). The carbon or graphite material may be selected from particles of carbon black, acetylene black, amorphous carbon, carbon nano-tube (CNT), carbon nano-fiber (CNF), activated carbon, expanded graphite flakes, micro-crystalline graphite, etc. The amount of this conductive additive is preferably less than 30% by weight, more preferably less than 20%, further more preferably less than 10% by weight based on the total composite particulate weight.

In some embodiments, the phosphorus material is bonded to surfaces of the (internal) graphene sheets in the core with a carbon or an electron-conducting polymer. The electron-conducting polymer may contain a conjugated polymer selected from Polyacetylene, Polythiophene, Poly(3-alkylthiophenes), Polypyrrole, Polyaniline, Poly(isothianaphthene), Poly(3,4-ethylenedioxythiophene), alkoxy-substituted Poly(p-phenylene vinylene), Poly(2,5-bis(cholestanoxy) phenylene vinylene), Poly(p-phenylene vinylene), Poly(2,5-dialkoxy) paraphenylene vinylene, Poly[(1,4-phenylene-1,2-diphenylvinylene)], Poly(3′,7′-dimethyloctyloxy phenylene vinylene), Polyparaphenylene, Polyparaphenylene, Polyparaphenylene sulphide, Polyheptadiyne, Poly(3-hexylthiophene), Poly(3-octylthiophene), Poly(3-cyclohexylthiophene), Poly(3-methyl-4-cyclohexylthiophene), Poly(2,5-dialkoxy-1,4-phenyleneethynylene), Poly(2-decyloxy-1,4-phenylene), Poly(9,9-dioctylfluorene), Polyquinoline, a derivative thereof, a copolymer thereof, or a combination thereof. The electron-conducting polymer may partially or fully cover or encapsulate the phosphorus material (in a form of coating or minute particles).

In certain embodiments, the encapsulating shell comprises an ion-conducting or electron-conducting material that bonds the multiple graphene sheets together (sealing off the shell) to prevent the direct contact of the phosphorus material with a liquid electrolyte in the lithium-ion battery or sodium-ion battery.

The graphene sheets in the core or the encapsulating shell preferably contain single-layer or few-layer graphene, wherein the few-layer graphene sheets have 2-10 layers of stacked graphene planes having an inter-plane spacing d₀₀₂ from 0.3354 nm to 0.6 nm as measured by X-ray diffraction and the single-layer or few-layer graphene sheets contain a pristine graphene material having essentially zero % of non-carbon elements, or a non-pristine graphene material having 0.001% to 25% by weight of non-carbon elements. The non-pristine graphene may be selected from graphene oxide, reduced graphene oxide, graphene fluoride, graphene chloride, graphene bromide, graphene iodide, hydrogenated graphene, nitrogenated graphene, doped graphene, chemically functionalized graphene, or a combination thereof.

In the anode particulate disclosed, the core may preferably further comprise a single pore or a plurality of pores to accommodate the volume expansion of the phosphorus material when the lithium-ion battery or sodium-ion battery is charged. In some preferred embodiments, the phosphorus material inside the core has a volume V₁ and the pore or pores have a total volume V₂, wherein the V₂/V₁ ratio is from 0.5 to 3.5.

The core may further comprise an electron-conducting material selected from a carbon, pitch, carbonized resin, conductive polymer, conductive organic material, metal, metal oxide, expanded graphite, or a combination thereof.

In some embodiments, the core further comprises a lithium or sodium ion-conducting material. The lithium or sodium ion-conducting material may be selected from amorphous carbon, an ion-conducting polymer, an ion-conducting polymer gel, an inorganic solid electrolyte, or a combination thereof. The ion-conducting polymer preferably comprises a polymer selected from poly(ethylene oxide), polypropylene oxide, poly(ethylene glycol), poly(acrylonitrile), poly(methyl methacrylate), poly(vinylidene fluoride), poly bis-methoxy ethoxyethoxide-phosphazene, polyvinyl chloride, polydimethylsiloxane, poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer electrolyte with a carboxylate anion, a sulfonylimide anion, or sulfonate anion, a crosslinked electrolyte of poly(ethylene glycol) diacrylate or poly(ethylene glycol) methyl ether acrylate, a sulfonated derivative thereof, or a combination thereof

In some embodiments, the phosphorous material particles are porous having surface pores, internal pores, or both surface and internal pores. The phosphorus material particles, porous or non-porous, may include nano-particles selected from nano-flakes, beads, pellets, spheres, wires, fibers, filaments, discs, ribbons, or rods, having a diameter or thickness from 1 nm to 100 nm.

In some embodiments, the phosphorus material particles comprise phosphorene, which contains mono-layer or few-layer 2D platelets of black phosphorus.

The disclosure also provides a powder mass comprising multiple anode particulates as described in the foregoing. The disclosure further provides an anode electrode comprising multiple anode particulates as herein disclosed as an anode material.

The disclosure also provides a lithium-ion battery comprising such an anode electrode, a cathode, and an electrolyte. Also provided is a sodium-ion battery, comprising such an anode electrode, a cathode, and an electrolyte.

The disclosure further provides a process for producing multiple anode particulates as defined in the foregoing, wherein the process comprises: (A) combining particles of the phosphorus material, multiple graphene sheets, optional particles of a carbon material, and a liquid medium to form a suspension; and (B) forming and drying the suspension into secondary particles or particulates wherein the particulate comprises a core-shell structure having a core of particles of the phosphorus material, internal graphene sheets, optional particles of a carbon material, and pores and a shell comprising multiple (external) graphene sheets embracing the core.

In certain embodiments, the process further comprises thermally vaporizing the phosphorus material and re-distributing the phosphorus material vapor in the core, making (e.g. via cooling) the vapor to deposit as a coating or nano particles of the phosphorus material supported on surfaces of the internal graphene sheets.

In some embodiments, step (A) of combining comprises a procedure of depositing phosphorus material onto graphene surfaces to produce phosphorus material-decorated graphene sheets, containing phosphorus particles or coating, phosphorene platelets, or metal phosphide particles or coating bonded on graphene surfaces. These phosphorus material-decorated graphene sheets are then dispersed in the liquid medium, along with carbon particles (if present), to form the suspension.

The procedure of depositing phosphorus material onto graphene surfaces may comprise operating physical vapor deposition, chemical vapor deposition, sputtering, plasma-enhanced deposition, solution phase deposition, chemical deposition, electrochemical deposition, thermal spraying, ultrasonic spraying, electrostatic deposition, electrophoretic deposition, laser ablation deposition, or a combination thereof.

In the disclosed process, step (B) may be followed by a procedure of incorporating a carbon material or a conducting polymer onto or into the encapsulating shell to bridge any gap between two graphene sheets or to seal off the encapsulating shell. The conducting polymer may contain an electron-conducting or conjugated polymer selected from Polyacetylene, Polythiophene, Poly(3-alkylthiophenes), Polypyrrole, Polyaniline, Poly(isothianaphthene), Poly(3,4-ethylenedioxythiophene), alkoxy-substituted Poly(p-phenylene vinylene), Poly(2,5-bis(cholestanoxy) phenylene vinylene), Poly(p-phenylene vinylene), Poly(2,5-dialkoxy) paraphenylene vinylene, Poly[(1,4-phenylene-1,2-diphenylvinylene)], Poly(3′,7′-dimethyloctyloxy phenylene vinylene), Polyparaphenylene, Polyparaphenylene, Polyparaphenylene sulphide, Polyheptadiyne, Poly(3-hexylthiophene), Poly(3-octylthiophene), Poly(3-cyclohexylthiophene), Poly(3-methyl-4-cyclohexylthiophene), Poly(2,5-dialkoxy-1,4-phenyleneethynylene), Poly(2-decyloxy-1,4-phenylene), Poly(9,9-dioctylfluorene), Polyquinoline, a derivative thereof, a copolymer thereof, or a combination thereof.

In the disclosed process, the conducting polymer may contain an ion-conducting polymer or a polymer gel electrolyte. The ion-conducting polymer or polymer gel electrolyte may comprise a polymer selected from poly(ethylene oxide), polypropylene oxide, poly(ethylene glycol), poly(acrylonitrile), poly(methyl methacrylate), poly(vinylidene fluoride), poly bis-methoxy ethoxyethoxide-phosphazene, polyvinyl chloride, polydimethylsiloxane, poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer electrolyte with a carboxylate anion, a sulfonylimide anion, or sulfonate anion, a crosslinked electrolyte of poly(ethylene glycol) diacrylate or poly(ethylene glycol) methyl ether acrylate, a sulfonated derivative thereof, or a combination thereof.

### BRIEF DESCRIPTION OF THE DRAWINGS

FIG. 1(A) The specific lithium ion storage capacity values (mAh/g) of select anode active materials (elements);

FIG. 1(B) The specific sodium ion storage capacity values (mAh/g) of select anode active materials;

FIG. 1(C) The volumetric lithium ion storage capacity values (mAh/cm³) of select anode active materials.

FIG. 2(A) A diagram showing the presently disclosed process for producing core-shell particulates, wherein the particulate comprises an encapsulating shell comprising external graphene sheets and a core comprising phosphorus material-decorated internal graphene sheets, according to some embodiments of instant disclosure.

FIG. 2(B) A diagram showing the presently disclosed process for producing core-shell particulates, wherein the particulate comprises an encapsulating shell comprising external graphene sheets and a core comprising phosphorus material-decorated internal graphene sheets, according to some embodiments of instant disclosure.

FIG. 2(C) Schematic drawing illustrating the core-shell particulate, according to some embodiments of the disclosure.

FIG. 3 A flow chart showing the most commonly used prior art process of producing highly oxidized graphene sheets (or nano graphene platelets, NGPs) that entails chemical oxidation/intercalation, rinsing, and high-temperature exfoliation procedures.

FIG. 4 Some examples of porous primary particles of phosphorus material.

FIG. 5 Three specific sodium ion storage capacity curves (mAh/g-composite) of three anode active materials: Samples 1A, 1B and 1C.

FIG. 6 Two specific lithium ion storage capacity curves (mAh/g-composite) of two anode active material core-shell particulates: In Sample 2A, the encapsulating shell is composed of graphene sheets bonded by PPy and the core comprises internal pristine graphene sheets and red phosphorus particles that are bonded to surfaces of internal graphene sheets via PPy. In Sample 2B, the encapsulating shell is composed of overlapped graphene sheets and the core comprises internal pristine graphene sheets and red phosphorus particles that are in physical contact with surfaces of internal graphene.

FIG. 7 The specific lithium ion storage capacity curves (mAh/g-composite) of two anode active materials: Sample 3A comprises core-shell particulates comprising graphene fluoride (GF)-encapsulated core of phosphorene/GF sheets and Sample 3B comprises phosphorene platelets and GF sheets packed into a sheet of paper-like structure.

### DETAILED DESCRIPTION OF PREFERRED EMBODIMENTS

A lithium-ion battery or sodium-ion battery cell is typically composed of an anode current collector (e.g. Cu foil), an anode or negative electrode active material layer (i.e. anode layer typically containing particles of an anode active material, conductive additive, and binder), a porous separator and/or an electrolyte component, a cathode or positive electrode active material layer (containing a cathode active material, conductive additive, and resin binder), and a cathode current collector (e.g. Al foil). More specifically, the anode layer is composed of particles of an anode active material (e.g. graphite, hard carbon, Sn, SnO₂, Si, or P), a conductive additive (e.g. carbon black particles), and a resin binder (e.g. SBR or PVDF). This anode layer is typically 50-300 μm thick (more typically 100-200 μm) to give rise to a sufficient amount of current per unit electrode area.

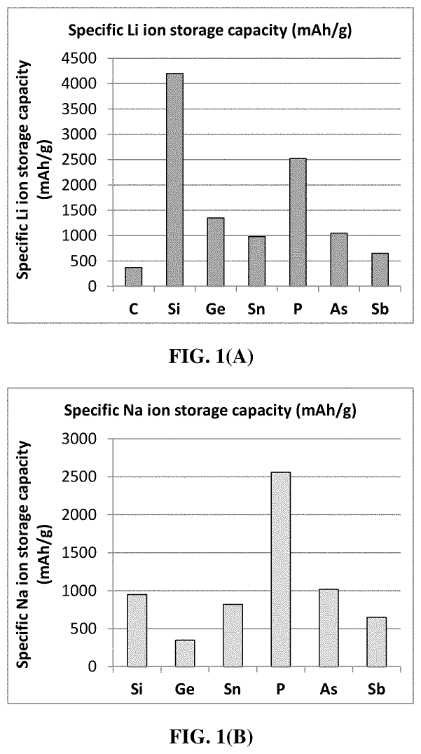

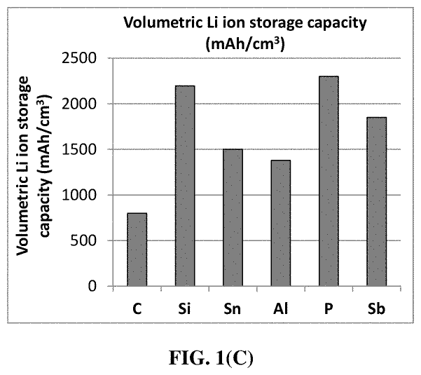

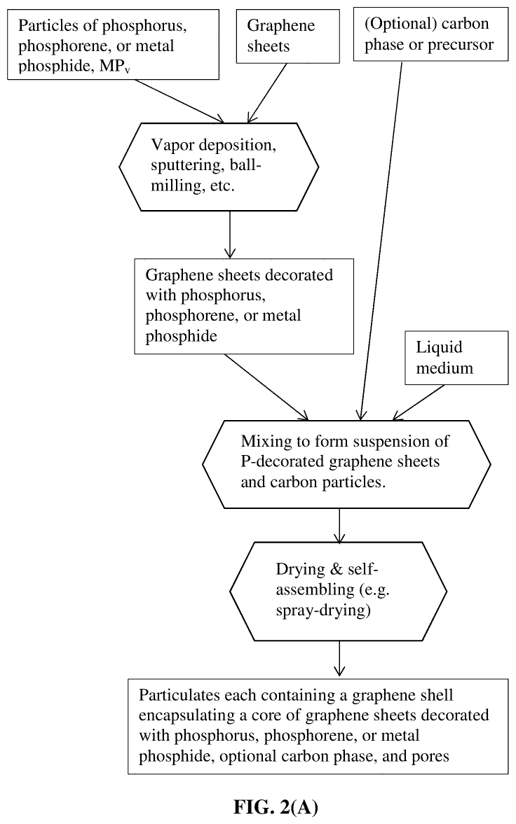

In order to obtain a higher energy density cell, the anode can be designed to contain higher-capacity anode active materials having a composition formula of LiₐA for Li-ion cells (wherein A is a metal or semiconductor element, such as Al and Si, and “a” satisfies 0<a≤5). These materials are of great interest due to their high theoretical capacity, e.g., Li₄Si (3,829 mAh/g), Li_{4.4}Si (4,200 mAh/g), Li_{4.4}Ge (1,623 mAh/g), Li_{4.4}Sn (993 mAh/g), Li₃Cd (715 mAh/g), Li₃Sb (660 mAh/g), Li_{4.4}Pb (569 mAh/g), LiZn (410 mAh/g), and Li₃Bi (385 mAh/g). The specific lithium ion storage capacity and sodium ion capacity values of select anode active materials are illustrated in FIGS. 1(A) and (B) and the volumetric lithium ion storage capacity values of select elements are presented in FIG. 1(C).

However, as discussed in the Background section, there are several problems associated with the implementation of these high-capacity anode active materials:
1) In an anode composed of these high-capacity materials, severe pulverization (fragmentation of the particles) occurs during the charge and discharge cycles due to severe expansion and contraction of the anode active material particles induced by the insertion and extraction of the lithium or sodium ions in and out of these particles. The expansion and contraction, and the resulting pulverization, of active material particles, lead to loss of contacts between active material particles and conductive additives and loss of contacts between the anode active material and its current collector. These adverse effects result in a significantly shortened charge-discharge cycle life.
2) The approach of using a composite composed of small electrode active particles protected by (dispersed in or encapsulated by) a less active or non-active matrix, e.g., carbon-coated P or Si particles, has failed to overcome the capacity decay problem. Presumably, the protective matrix can provide a cushioning effect for particle expansion or shrinkage, and prevent the electrolyte from contacting and reacting with the electrode active material. Unfortunately, when an active material particle, such as P particle, expands (e.g. up to a volume expansion of 300%) during the battery charge step, the protective coating is easily broken due to the mechanical weakness and/or brittleness of the protective coating materials. There has been no high-strength and high-toughness material available that is itself also lithium ion conductive.
3) The approach of using a conventional core-shell structure (e.g. a P nano particle encapsulated in a carbon shell) also has not solved the capacity decay issue. A P particle can be encapsulated by a carbon shell to form a core-shell structure (e.g. P core and carbon shell). As the lithium-ion battery is charged, the anode active material (carbon-encapsulated P particle) is intercalated with lithium or sodium ions and, hence, the P particle expands. Due to the brittleness of the encapsulating shell (carbon), the shell is broken into segments, exposing the underlying P to electrolyte and subjecting the P to undesirable reactions with electrolyte during repeated charges/discharges of the battery. These reactions continue to consume the electrolyte and reduce the cell's ability to store lithium or sodium ions.

In other words, there are several conflicting factors that must be considered concurrently when it comes to the design and selection of an anode active material in terms of material type, shape, size, porosity, and electrode layer thickness. Thus far, there has been no effective solution offered by any prior art teaching to these conflicting problems. We have solved these challenging issues that have troubled battery designers and electrochemists alike for more than 30 years by developing the approach of graphene-encapsulated highly porous particulates (secondary particles preferably in a substantially core-shell structure). The disclosed core-shell particulate comprises a core and a shell encapsulating the core, wherein the core comprises one or multiple primary particles of an anode active material (P) and internal graphene sheets residing in a porous core. The phosphorus material, in the form of nano particles, phosphorene platelets, or coating, is deposited on surfaces of the internal graphene sheets. The pores in the core can accommodate the volume expansion of the primary particle(s) of the anode active material. The encapsulating shell, comprising graphene sheets and preferably along with a conducting binder or matrix material, encapsulates the porous core.

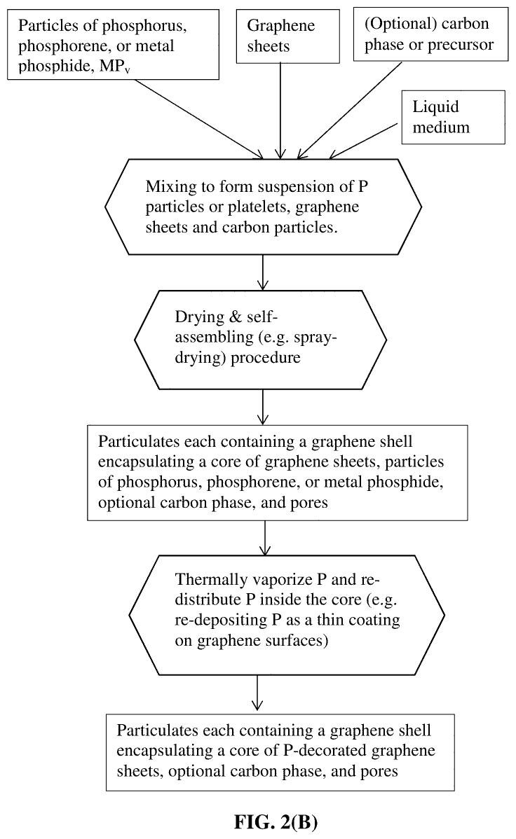

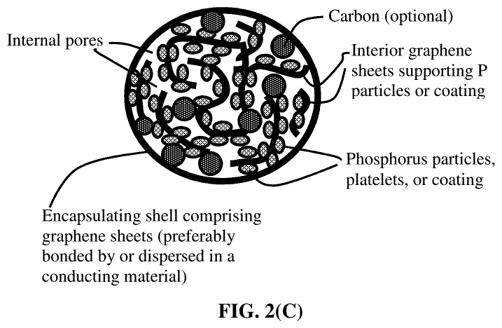

In certain embodiments, the present disclosure provides a graphene-encapsulated phosphorus anode particulate (or multiple particulates) for a lithium battery or sodium ion battery. As schematically illustrated in FIG. 2(C), the particulate comprises: (A) a core comprising one or a plurality of phosphorus material-decorated graphene sheets (internal graphene sheets), wherein the decorated graphene sheets have a length or width from 5 nm to 100 μm and contain single-layer or few-layer graphene sheets and the phosphorus material is in a form of particles or coating having a diameter or thickness from 0.5 nm to 10 μm (preferably <100 nm) and is selected from red phosphorus, black phosphorus, violet phosphorus, a metal phosphide, MP_{y}, or a combination thereof, wherein M=Mn, V, Sn, Ni, Cu, Fe, Co, Zn, Ge, Se, Mo, Ga, In, or an alloy thereof, and y is from 1 to 4; and (B) an encapsulating shell that embraces or encapsulates the core, wherein the encapsulating shell comprises multiple graphene sheets (exterior graphene sheets) and have a thickness from 0.34 nm to 5 μm.

The general reactions of phosphorus carbon composites with lithium/sodium may be summarized as follows:

P+xLi+/Na++xe− [symbol] →LixP/NaxP (1)

LiₓP/NaₓP+(3/x)Li⁺/Na⁺+(3/x)e− [symbol] Li₃P/Na₃P (2)

During the lithiation/sodiation process, phosphorus reacts with lithium/sodium to form the intermediate compounds of LiₓP/NaₓP, with the final products of Li₃P/Na₃P. The delithiation/desodiation process involves a stepwise lithium/sodium ion extraction from the fully lithiated/sodiatied Li₃P/Na₃P, corresponding to several plateaus in the voltage profile, as well as the several cathodic peaks in the cyclic voltammogram.

The ion storing mechanism of metal phosphides, MP_{y} (M=Mn, V, Sn, Ni, Cu, Fe, Co, Zn, Ge, Se, Mo, Ga, In; y=1-4), may be categorized according to the features of the metal and the metal-phosphorus bond stability when reacted with Li or Na. The mechanisms may be divided into the following two categories.

Insertion reaction: MPₙ [symbol] LiₓMPₙ (3)

Conversion reaction: MPₙ [symbol] M(LiₓM)+LiₓP (4)

When the metal phosphides have stable crystalline structures, LiₓMP_{y} is formed through the insertion reaction mechanism. However, the structures of phosphides typically collapse within a few insertions/extractions, or full discharge/charge reactions through the conversion reaction mechanisms, providing nanosized Li₃P and M(LiₓM), with bonds between metal and phosphorus broken. The conversion reaction produced nano-crystallites with less severe structural stress. The redox nature of the phosphorus dominates the reactivity of metal phosphides with lithium, and the number of electrons in the anion dominates the capacities. The Na storage mechanism of metal phosphides remains poorly understood and needs further investigations.

Graphene, as a two-dimensional carbon material, exhibits high conductivity, high surface area (theoretically 2630 m²/g), high degree of mechanical flexibility (due to its thinness), and high mechanical strength. These outstanding properties can impart a good interfacial contact ability to anchor and disperse phosphorus particles very uniformly on graphene surfaces. The mechanical flexibility and strength also enable additional graphene sheets to wrap around or encapsulate a core of graphene-supported phosphorus particles to form secondary particles. These characteristics can effectively restrain the aggregation and sintering of phosphorus particles due to volume changes during battery charge/discharge cycling. The graphene sheet-based encapsulating shells, if properly designed, can also seal the encapsulated core structure, preventing direct contact between phosphorus particles and liquid electrolyte solvent. Such a contact could induce repeated formation and destruction of solid-electrolyte interface (SEI), leading to rapid capacity decay.

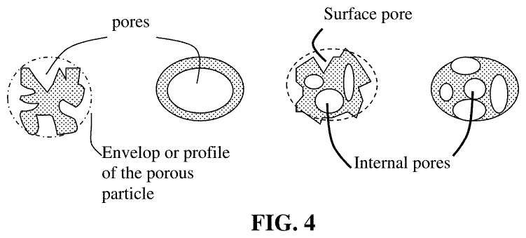

The primary anode material particles (P) may be a solid, non-porous material or may be intrinsically porous. The porous primary particles contain a pore volume Vpp and solid volume V₁, wherein the primary pore volume Vpp is not part of (but being additional to) the core pore volume Vc, and V₂=Vpp+Vc. The encapsulating shell (graphene sheets, typically also bonded by a conducting material) that has a thickness from 1 nm to 10 μm (preferably from 1 nm to 100 nm). The pores in the core have a total volume V₂, wherein the pore-to-active material ratio (V₂/V₁ ratio) is preferably and typically from 0.5/1.0 to 5/1.0 (more preferably from 1.0/1.0 to 3.0/1.0). The pores in the particulate can accommodate the volume expansion of the phosphorus material when the battery is charged. Some pores in or on primary particles are schematically illustrated in FIG. 4. In addition, to create pores in the core of a secondary particle (particulate), one may introduce a sacrificial material (e.g. sugar, salt, polymer, etc.) in the core and then removing the sacrificial material (e.g. dissolving salt or sugar with water or carbonizing sugar or polymer) after the particulate is formed.

The phosphorus material may be in a form of minute solid or porous particles (primary anode material particles) or coating having a diameter or thickness from 0.5 nm to 2 μm (preferably from 1 nm to 100 nm) that is deposited on or bonded to surfaces of internal graphene sheets. In certain embodiments, the P material is bonded to surfaces of the graphene sheets with an electron-conducting polymer.

Preferably, the bonding electron-conducting polymer contains a conjugated polymer selected from Polyacetylene, Polythiophene, Poly(3-alkylthiophenes), Polypyrrole, Polyaniline, Poly(isothianaphthene), Poly(3,4-ethylenedioxythiophene) (PEDOT), alkoxy-substituted Poly(p-phenylene vinylene), Poly(2,5-bis(cholestanoxy) phenylene vinylene), Poly(p-phenylene vinylene), Poly(2,5-dialkoxy) paraphenylene vinylene, Poly[(1,4-phenylene-1,2-diphenylvinylene)], Poly(3′,7′-dimethyloctyloxy phenylene vinylene), Polyparaphenylene, Polyparaphenylene, Polyparaphenylene sulphide, Polyheptadiyne, Poly(3-hexylthiophene), Poly(3-octylthiophene), Poly(3-cyclohexylthiophene), Poly(3-methyl-4-cyclohexylthiophene), Poly(2,5-dialkoxy-1,4-phenyleneethynylene), Poly(2-decyloxy-1,4-phenylene), Poly(9,9-dioctylfluorene), Polyquinoline, a derivative thereof, a copolymer thereof, or a combination thereof.

In some embodiments, the electron-conducting polymer partially or fully covers or encapsulates the anode active material. In some embodiments, the conducting polymer serves as an adhesive that chemically bonds the anode active material particles to the graphene surface.

The encapsulating shell may contain just the graphene sheets alone without using a binder or matrix. Alternatively, the graphene sheets may be bonded by a binder (e.g. a conductive polymer or carbon binder) or dispersed in a resin or carbon matrix. Preferably, the encapsulating shell has a thickness from 1 nm to 10 μm (preferably less than 1 μm and most preferably <100 nm), and a lithium ion conductivity from 10⁻⁸ S/cm to 10⁻² S/cm (more typically from 10⁻⁵ S/cm to 10⁻³ S/cm). The encapsulating shell preferably has an electrical conductivity from 10⁻⁷ S/cm to 3,000 S/cm, up to 20,000 S/cm (more typically from 10⁻⁴ S/cm to 1000 S/cm) when measured at room temperature on a separate cast thin film 20 μm thick.

The conductive polymer in the shell may be an electron-conducting polymer containing a conjugated polymer selected from Polyacetylene, Polythiophene, Poly(3-alkylthiophenes), Polypyrrole, Polyaniline, Poly(isothianaphthene), Poly(3,4-ethylenedioxythiophene) (PEDOT), alkoxy-substituted Poly(p-phenylene vinylene), Poly(2,5-bis(cholestanoxy) phenylene vinylene), Poly(p-phenylene vinylene), Poly(2,5-dialkoxy) paraphenylene vinylene, Poly[(1,4-phenylene-1,2-diphenylvinylene)], Poly(3′,7′-dimethyloctyloxy phenylene vinylene), Polyparaphenylene, Polyparaphenylene, Polyparaphenylene sulphide, Polyheptadiyne, Poly(3-hexylthiophene), Poly(3-octylthiophene), Poly(3-cyclohexylthiophene), Poly(3-methyl-4-cyclohexylthiophene), Poly(2,5-dialkoxy-1,4-phenyleneethynylene), Poly(2-decyloxy-1,4-phenylene), Poly(9,9-dioctylfluorene), Polyquinoline, a derivative thereof, a copolymer thereof, or a combination thereof.

The conductive polymer in the shell may be an ion-conducting polymer. The lithium ion-conducting or sodium ion-conducting polymer may be selected from poly(ethylene oxide), polypropylene oxide, poly(ethylene glycol), poly(acrylonitrile), poly(methyl methacrylate), poly(vinylidene fluoride), poly bis-methoxy ethoxyethoxide-phosphazene, polyvinyl chloride, polydimethylsiloxane, poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer electrolyte with a carboxylate anion, a sulfonylimide anion, or sulfonate anion, a crosslinked electrolyte of poly(ethylene glycol) diacrylate or poly(ethylene glycol) methyl ether acrylate, a sulfonated derivative thereof, or a combination thereof. The ion conductivity of these polymers can be from 10⁻⁸ S/cm to 10⁻² S/cm (more typically from 10⁻⁵ S/cm to 10⁻³ S/cm).

A single or a plurality of solid or porous primary P particles may be deposited onto surfaces of a graphene sheet (with or without the use of an adhesive or binder). The procedure of depositing phosphorus material onto graphene surfaces comprises physical vapor deposition, chemical vapor deposition, sputtering, plasma-enhanced deposition, solution phase deposition, chemical deposition, electrochemical deposition, thermal spraying, ultrasonic spraying, electrostatic deposition, electrophoretic deposition, laser ablation deposition, or a combination thereof. Such deposition may be simply accomplished via, for instance, mechanical impacting or ball milling. Primary P particles (including phosphorene platelets) and its binder or matrix resin may be applied to the surfaces of graphene sheets using a broad array of known techniques, such as spray drying, fluidized bed coating, and other micro-encapsulating procedures. Anode material coating may be deposited onto graphene surfaces using physical vapor deposition, sputtering, chemical vapor deposition, solution coating deposition, etc.

The primary P particles themselves may be porous having porosity in the form of surface pores and/or internal pores. FIG. 4 shows some examples of porous primary P particles. These pores of the primary particles allow the particle to expand into the free space without a significant overall volume increase of the particulate and without inducing any significant volume expansion of the entire anode electrode.

This amount of pore volume inside the particulate (surface or internal pores of porous primary anode particles) provides empty space to accommodate the volume expansion of the anode active material so that the thin encapsulating layer would not significantly expand (not to exceed 50% volume expansion of the particulate) when the lithium or sodium ion battery is charged. Preferably, the particulate does not increase its volume by more than 20%, further preferably less than 10% and most preferably by approximately 0% when the battery is charged. Such a constrained volume expansion of the particulate would not only reduce or eliminate the volume expansion of the anode electrode but also reduce or eliminate the issue of repeated formation and destruction of a solid-electrolyte interface (SEI) phase. We have discovered that this strategy surprisingly results in significantly reduced battery capacity decay rate and dramatically increased charge/discharge cycle numbers. These results are unexpected and highly significant with great utility value.

Carbon materials can assume an essentially amorphous structure (glassy carbon), a highly organized crystal (graphite), or a whole range of intermediate structures that are characterized in that various proportions and sizes of graphite crystallites and defects are dispersed in an amorphous matrix. Typically, a graphite crystallite is composed of a number of graphene sheets or basal planes that are bonded together through van der Waals forces in the c-axis direction, the direction perpendicular to the basal plane. These graphite crystallites are typically micron- or nanometer-sized. The graphite crystallites are dispersed in or connected by crystal defects or an amorphous phase in a graphite particle, which can be a graphite flake, carbon/graphite fiber segment, carbon/graphite whisker, or carbon/graphite nano-fiber. In other words, graphene planes (hexagonal lattice structure of carbon atoms) constitute a significant portion of a graphite particle.

A graphene sheet or nano graphene platelet (NGP) is essentially composed of a sheet of graphene plane or multiple sheets of graphene plane stacked and bonded together (typically, on an average, less than 10 sheets per multi-layer platelet). Each graphene plane, also referred to as a graphene sheet or a hexagonal basal plane, comprises a two-dimensional hexagonal structure of carbon atoms. Each platelet has a length and a width parallel to the graphene plane and a thickness orthogonal to the graphene plane. A single-sheet graphene is as thin as 0.34 nm. A few-layer graphene sheet contains 2-10 graphene planes stacked together. The length and width of a NGP are typically between 200 nm and 20 μm, but could be longer or shorter, depending upon the sizes of source graphite material particles.

Our research group pioneered the development of graphene materials and related production processes as early as 2002: (1) B. Z. Jang and W. C. Huang, “Nano-scaled Graphene Plates,” U.S. Pat. No. 7,071,258 (Jul. 4, 2006), application submitted on Oct. 21, 2002; (2) B. Z. Jang, et al. “Process for Producing Nano-scaled Graphene Plates,” U.S. Patent Publication (U.S. Pat. Pub. No. 2005/0271574) (now abandoned); and (3) B. Z. Jang, A. Zhamu, and J. Guo, “Process for Producing Nano-scaled Platelets and Nanocomposites,” US Pat. Publication Number (U.S. Pat. Pub. No. 2008/0048152) (now abandoned).

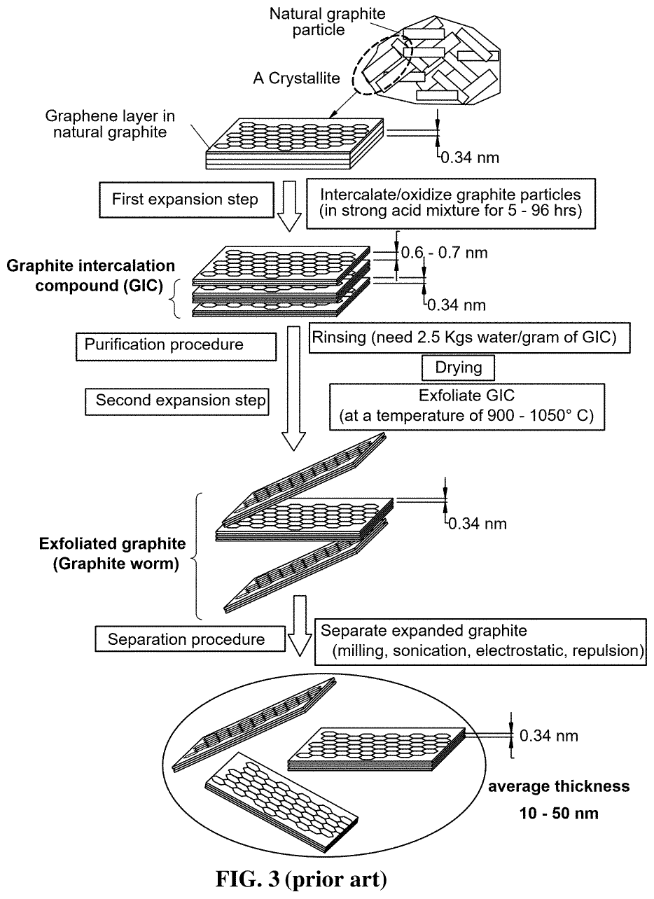

A highly useful approach (FIG. 3) entails treating natural graphite powder with an intercalant and an oxidant (e.g., concentrated sulfuric acid and nitric acid, respectively) to obtain a graphite intercalation compound (GIC) or, actually, graphite oxide (GO). [William S. Hummers, Jr., et al., Preparation of Graphitic Oxide, Journal of the American Chemical Society, 1958, p. 1339.] Prior to intercalation or oxidation, graphite has an inter-graphene plane spacing of approximately 0.335 nm (L_{d}=½ d₀₀₂=0.335 nm). With an intercalation and oxidation treatment, the inter-graphene spacing is increased to a value typically greater than 0.6 nm. This is the first expansion stage experienced by the graphite material during this chemical route. The obtained GIC or GO is then subjected to further expansion (often referred to as exfoliation) using either a thermal shock exposure or a solution-based, ultrasonication-assisted graphene layer exfoliation approach.

It may be noted that if natural graphite powder is dispersed in an oxidant (e.g., a mixture of concentrated sulfuric acid and nitric acid or potassium permanganate) for a sufficient period of time one can obtain a GO material having an oxygen content greater than 30% by weight (preferably >35%), which can be formed into a GO gel state via water rinsing and mechanical shearing.

In the thermal shock exposure approach, the GIC or GO is exposed to a high temperature (typically 800-1,050° C.) for a short period of time (typically 15 to 60 seconds) to exfoliate or expand the GIC or GO for the formation of exfoliated or further expanded graphite, which is typically in the form of a “graphite worm” composed of graphite flakes that are still interconnected with one another. This thermal shock procedure can produce some separated graphite flakes or graphene sheets, but normally the majority of graphite flakes remain interconnected. Typically, the exfoliated graphite or graphite worm is then subjected to a flake separation treatment using air milling, mechanical shearing, or ultrasonication in water. Hence, approach 1 basically entails three distinct procedures: first expansion (oxidation or intercalation), further expansion (or “exfoliation”), and separation.

In the solution-based separation approach, the expanded or exfoliated GO powder is dispersed in water or aqueous alcohol solution, which is subjected to ultrasonication. It is important to note that in these processes, ultrasonification is used after intercalation and oxidation of graphite (i.e., after first expansion) and typically after thermal shock exposure of the resulting GIC or GO (after second expansion). Alternatively, the GO powder dispersed in water is subjected to an ion exchange or lengthy purification procedure in such a manner that the repulsive forces between ions residing in the inter-planar spaces overcome the inter-graphene van der Waals forces, resulting in graphene layer separations.

In the aforementioned examples, the starting material for the preparation of graphene sheets or NGPs is a graphitic material that may be selected from the group consisting of natural graphite, artificial graphite, graphite oxide, graphite fluoride, graphite fiber, carbon fiber, carbon nano-fiber, carbon nano-tube, mesophase carbon micro-bead (MCMB) or carbonaceous micro-sphere (CMS), soft carbon, hard carbon, and combinations thereof.

Graphite oxide may be prepared by dispersing or immersing a laminar graphite material (e.g., powder of natural flake graphite or synthetic graphite) in an oxidizing agent, typically a mixture of an intercalant (e.g., concentrated sulfuric acid) and an oxidant (e.g., nitric acid, hydrogen peroxide, sodium perchlorate, potassium permanganate) at a desired temperature (typically 0-70° C.) for a sufficient length of time (typically 4 hours to 5 days). The resulting graphite oxide particles are then rinsed with water several times to adjust the pH values to typically 2-5. The resulting suspension of graphite oxide particles dispersed in water is then subjected to ultrasonication to produce a dispersion of separate graphene oxide sheets dispersed in water. A small amount of reducing agent (e.g. Na₄B) may be added to obtain reduced graphene oxide (RGO) sheets.

In order to reduce the time required to produce a precursor solution or suspension, one may choose to oxidize the graphite to some extent for a shorter period of time (e.g., 30 minutes-4 hours) to obtain graphite intercalation compound (GIC). The GIC particles are then exposed to a thermal shock, preferably in a temperature range of 600-1,100° C. for typically 15 to 60 seconds to obtain exfoliated graphite or graphite worms, which are optionally (but preferably) subjected to mechanical shearing (e.g. using a mechanical shearing machine or an ultrasonicator) to break up the graphite flakes that constitute a graphite worm. Either the already separated graphene sheets (after mechanical shearing) or the un-broken graphite worms or individual graphite flakes are then re-dispersed in water, acid, or organic solvent and ultrasonicated to obtain a graphene dispersion.

The pristine graphene material is preferably produced by one of the following three processes: (A) Intercalating the graphitic material with a non-oxidizing agent, followed by a thermal or chemical exfoliation treatment in a non-oxidizing environment; (B) Subjecting the graphitic material to a supercritical fluid environment for inter-graphene layer penetration and exfoliation; or (C) Dispersing the graphitic material in a powder form to an aqueous solution containing a surfactant or dispersing agent to obtain a suspension and subjecting the suspension to direct ultrasonication to obtain a graphene dispersion.

In Procedure (A), a particularly preferred step comprises (i) intercalating the graphitic material with a non-oxidizing agent, selected from an alkali metal (e.g., potassium, sodium, lithium, or cesium), alkaline earth metal, or an alloy, mixture, or eutectic of an alkali or alkaline metal; and (ii) a chemical exfoliation treatment (e.g., by immersing potassium-intercalated graphite in ethanol solution).

In Procedure (B), a preferred step comprises immersing the graphitic material to a supercritical fluid, such as carbon dioxide (e.g., at temperature T>31° C. and pressure P>7.4 MPa) and water (e.g., at T>374° C. and P>22.1 MPa), for a period of time sufficient for inter-graphene layer penetration (tentative intercalation). This step is then followed by a sudden de-pressurization to exfoliate individual graphene layers. Other suitable supercritical fluids include methane, ethane, ethylene, hydrogen peroxide, ozone, water oxidation (water containing a high concentration of dissolved oxygen), or a mixture thereof.

In Procedure (C), a preferred step comprises (a) dispersing particles of a graphitic material in a liquid medium containing therein a surfactant or dispersing agent to obtain a suspension or slurry; and (b) exposing the suspension or slurry to ultrasonic waves (a process commonly referred to as ultrasonication) at an energy level for a sufficient length of time to produce a graphene dispersion of separated graphene sheets (non-oxidized NGPs) dispersed in a liquid medium (e.g. water, alcohol, or organic solvent).

Graphene materials can be produced with an oxygen content no greater than 25% by weight, preferably below 20% by weight, further preferably below 5%. Typically, the oxygen content is between 5% and 20% by weight. The oxygen content can be determined using chemical elemental analysis and/or X-ray photoelectron spectroscopy (XPS). When the oxygen content of graphene oxide exceeds 30% by weight (more typically when >35%), the GO molecules dispersed or dissolved in water for a GO gel state.

The laminar graphite materials used in the prior art processes for the production of the GIC, graphite oxide, and subsequently made exfoliated graphite, flexible graphite sheets, and graphene platelets were, in most cases, natural graphite. However, the present disclosure is not limited to natural graphite. The starting material may be selected from the group consisting of natural graphite, artificial graphite (e.g., highly oriented pyrolytic graphite, HOPG), graphite oxide, graphite fluoride, graphite fiber, carbon fiber, carbon nano-fiber, carbon nano-tube, mesophase carbon micro-bead (MCMB) or carbonaceous micro-sphere (CMS), soft carbon, hard carbon, and combinations thereof. All of these materials contain graphite crystallites that are composed of layers of graphene planes stacked or bonded together via van der Waals forces. In natural graphite, multiple stacks of graphene planes, with the graphene plane orientation varying from stack to stack, are clustered together. In carbon fibers, the graphene planes are usually oriented along a preferred direction. Generally speaking, soft carbons are carbonaceous materials obtained from carbonization of liquid-state, aromatic molecules. Their aromatic ring or graphene structures are more or less parallel to one another, enabling further graphitization. Hard carbons are carbonaceous materials obtained from aromatic solid materials (e.g., polymers, such as phenolic resin and polyfurfuryl alcohol). Their graphene structures are relatively randomly oriented and, hence, further graphitization is difficult to achieve even at a temperature higher than 2,500° C. But, graphene sheets do exist in these carbons.

Fluorinated graphene or graphene fluoride is herein used as an example of the halogenated graphene material group. There are two different approaches that have been followed to produce fluorinated graphene: (1) fluorination of pre-synthesized graphene: This approach entails treating graphene prepared by mechanical exfoliation or by CVD growth with fluorinating agent such as XeF₂, or F-based plasmas; (2) Exfoliation of multilayered graphite fluorides: Both mechanical exfoliation and liquid phase exfoliation of graphite fluoride can be readily accomplished [F. Karlicky, et al. “Halogenated Graphenes: Rapidly Growing Family of Graphene Derivatives” ACS Nano, 2013, 7 (8), pp 6434-6464].

Interaction of F₂ with graphite at high temperature leads to covalent graphite fluorides (CF)ₙ or (C₂F)ₙ, while at low temperatures graphite intercalation compounds (GIC) CₓF (2≤x≤24) form. In (CF)ₙ carbon atoms are sp3-hybridized and thus the fluorocarbon layers are corrugated consisting of trans-linked cyclohexane chairs. In (C₂F)ₙ only half of the C atoms are fluorinated and every pair of the adjacent carbon sheets are linked together by covalent C—C bonds. Systematic studies on the fluorination reaction showed that the resulting F/C ratio is largely dependent on the fluorination temperature, the partial pressure of the fluorine in the fluorinating gas, and physical characteristics of the graphite precursor, including the degree of graphitization, particle size, and specific surface area. In addition to fluorine (F₂), other fluorinating agents may be used, although most of the available literature involves fluorination with F₂ gas, sometimes in presence of fluorides.

For exfoliating a layered precursor material to the state of individual single graphene layers or few-layers, it is necessary to overcome the attractive forces between adjacent layers and to further stabilize the layers. This may be achieved by either covalent modification of the graphene surface by functional groups or by non-covalent modification using specific solvents, surfactants, polymers, or donor-acceptor aromatic molecules. The process of liquid phase exfoliation includes ultra-sonic treatment of a graphite fluoride in a liquid medium to produce graphene fluoride sheets dispersed in the liquid medium. The resulting dispersion can be directly used in the graphene deposition of polymer component surfaces.

The nitrogenation of graphene can be conducted by exposing a graphene material, such as graphene oxide, to ammonia at high temperatures (200-400° C.). Nitrogenated graphene could also be formed at lower temperatures by a hydrothermal method; e.g. by sealing GO and ammonia in an autoclave and then increased the temperature to 150-250° C. Other methods to synthesize nitrogen doped graphene include nitrogen plasma treatment on graphene, arc-discharge between graphite electrodes in the presence of ammonia, ammonolysis of graphene oxide under CVD conditions, and hydrothermal treatment of graphene oxide and urea at different temperatures.

For the purpose of defining the claims of the instant application, NGPs or graphene materials include discrete sheets/platelets of single-layer and multi-layer (typically less than 10 layers, the few-layer graphene) pristine graphene, graphene oxide, reduced graphene oxide (RGO), graphene fluoride, graphene chloride, graphene bromide, graphene iodide, hydrogenated graphene, nitrogenated graphene, chemically functionalized graphene, doped graphene (e.g. doped by B or N). Pristine graphene has essentially 0% oxygen. RGO typically has an oxygen content of 0.001%-5% by weight. Graphene oxide (including RGO) can have 0.001%-50% by weight of oxygen. Other than pristine graphene, all the graphene materials have 0.001%-50% by weight of non-carbon elements (e.g. O, H, N, B, F, Cl, Br, I, etc.). These materials are herein referred to as non-pristine graphene materials. The presently invented graphene can contain pristine or non-pristine graphene and the invented method allows for this flexibility. These graphene sheets all can be chemically functionalized.

FIG. 2(C) schematically illustrates the core-shell particulate, according to some embodiments of the disclosure. This particulate structure may be produced by the processes schematically shown in FIGS. 2(A) and (B).

In some embodiments, as shown in FIG. 2(A), a process may begin with depositing particles or coating of phosphorus, phosphorene, or metal phosphide, MP_{y} onto surfaces of multiple graphene sheets (pristine graphene, GO, RGO, fluorinated graphene, etc.) using CVD, plasma-enhanced CVD, physical vapor deposition, sputtering, solution deposition, melt impregnation, chemical reaction deposition, etc. The resulting phosphorus-decorated graphene sheets, along with a conductive material (e.g. carbon particles, carbon nanotubes, carbon nano-fibers, etc.), are then dispersed in a liquid medium to form a suspension. This procedure is followed by forming and drying the suspension into secondary particles or particulates (using spray-drying or other known secondary particle forming procedures) in such a manner that the particulate comprises a core-shell structure having a core of particles of the phosphorus material, internal graphene sheets, optional particles of a carbon material (conductive additive), and pores and a shell comprising multiple (external) graphene sheets embracing the core.

In certain embodiments, as illustrated in FIG. 2(B), the process begins with dispersing particles of phosphorus, phosphorene, or metal phosphide, multiple graphene sheets, and an optional conductive additive into a liquid medium (e.g. water, organic solvent, etc.) to form a suspension. This procedure is followed by forming and drying the suspension into secondary particles or particulates (e.g. using spray-drying or other known secondary particle-forming procedures).

In certain preferred embodiments, the process further comprises thermally vaporizing or heating the phosphorus material and re-distributing the phosphorus material vapor in the core, cooling and making the vapor to deposit as a coating or nano particles of the phosphorus material onto surfaces of the internal graphene sheets. Such a procedure enables the conversion of micron- or sub-micron particles (e.g. 0.1 μm to 10 μm) of a phosphorus material in situ into a large number of ultra-fine particles (0.5-100 nm in diameter) or ultra-thin coating (1-100 nm) deposited on graphene surfaces.

All types of porous anode active material particles may be produced by depositing the anode active material onto surfaces or into pores of a sacrificial material structure, followed by removing the sacrificial material. Such a deposition can be conducted using CVD, plasma-enhanced CVD, physical vapor deposition, sputtering, solution deposition, melt impregnation, chemical reaction deposition, etc.

In some embodiments, prior to the graphene encapsulating process, the primary particles of P material (supported on graphene surfaces) contain P particles that are pre-coated with a coating of a conductive material selected from carbon, pitch, carbonized resin, a conductive polymer, a conductive organic material, a graphene coating (e.g. graphene sheets), a metal coating, a metal oxide shell, or a combination thereof. The coating layer thickness is preferably in the range from 1 nm to 10 μm, preferably from 2 nm to 1 μm, and further preferably from 5 nm to 100 nm. This coating is implemented for the purpose of establishing a stable solid-electrolyte interface (SEI) to increase the useful cycle life of a lithium-ion battery. Coating of graphene sheets on anode active material particles may be accomplished by using a similarly configured impact transfer process (direct transfer or indirect transfer) as described above for the composite particles.

In some embodiments, the particles of solid anode active material (e.g. MP_{y}) contain particles that are, prior to being deposited onto graphene surfaces, pre-coated with a carbon precursor material selected from a coal tar pitch, petroleum pitch, meso-phase pitch, polymer, organic material, or a combination thereof so that the carbon precursor material resides between surfaces of the solid phosphorus material particles and the graphene sheets, and the method further contains a step of heat-treating the graphene-embraced anode material-decorated graphene sheets to convert the carbon precursor material to a carbon material coated on primary active material particle surfaces.

The graphene-encapsulated anode particulates may be exposed to a matrix or binder material (e.g. a conducting polymer) that chemically bonds the graphene sheets together or simply fills the gaps between graphene sheets in the encapsulating shell. The matrix/binder material helps to completely seal off the embracing graphene sheets to prevent direct contact of the embraced anode active material (phosphorus material) with liquid electrolyte, which otherwise continues to form additional SEI via continuously consuming the lithium ions or solvent in the electrolyte, leading to rapid capacity decay.

In some embodiments, the method further comprises a step of exposing the graphene-embraced particulates to a liquid or vapor of a conductive material that is conductive to electrons and/or ions of lithium or sodium. This procedure serves to provide a stable SEI or to make the SEI more stable.

There are three broad categories of micro-encapsulation methods that can be implemented to produce particulates of graphene shell-encapsulated core comprising internal graphene sheets and a phosphorus material in the form of nanoparticles, platelets, or coating supported by the internal graphene sheets or in physical contact thereof. These include physical methods, physico-chemical methods, and chemical methods. The physical methods include pan-coating, air-suspension coating, centrifugal extrusion, vibration nozzle, and spray-drying methods. The physico-chemical methods include ionotropic gelation and coacervation-phase separation methods. The chemical methods include interfacial polycondensation, interfacial cross-linking, in-situ polymerization, and matrix polymerization.

Pan-coating method: The pan coating process involves tumbling a mixture of graphene sheets, particles of a phosphorus material, and an optional conductive additive in a pan or a similar device while the encapsulating material (e.g. graphene sheets dispersed in a monomer/oligomer, polymer melt, polymer/solvent solution) is applied slowly until a desired encapsulating shell thickness is attained.

Air-suspension coating method: In the air suspension coating process, a mixture of graphene sheets, particles of a phosphorus material, and an optional conductive additive is dispersed into the supporting air stream in an encapsulating chamber. A controlled stream of a suspension comprising graphene sheets dispersed in a polymer-solvent solution (e.g. polymer or its monomer or oligomer dissolved in a solvent; or its monomer or oligomer alone in a liquid state) is concurrently introduced into this chamber, allowing the solution to hit and coat the suspended mixture particles. These suspended particles are encapsulated (fully coated) with polymer/graphene sheets while the volatile solvent is removed, leaving a thin layer of polymer-bonded graphene sheets on surfaces of the core. This process may be repeated several times until the required parameters, such as full-coating thickness (i.e. encapsulating shell or wall thickness), are achieved.

Centrifugal extrusion: Graphite/carbon particles may be encapsulated with a polymer/anode active material using a rotating extrusion head containing concentric nozzles. In this process, a stream of core fluid (slurry containing graphite/carbon particles dispersed in a solvent) is surrounded by a sheath of shell solution or melt containing anode active material particles dispersed therein. As the device rotates and the stream moves through the air it breaks, due to Rayleigh instability, into droplets of core, each coated with the shell solution. While the droplets are in flight, the molten shell may be hardened or the solvent may be evaporated from the shell solution. If needed, the capsules can be hardened after formation by catching them in a hardening bath. Since the drops are formed by the breakup of a liquid stream, the process is only suitable for liquid or slurry. A high production rate can be achieved. Up to 22.5 kg of microcapsules can be produced per nozzle per hour and extrusion heads containing 16 nozzles are readily available.

Vibrational nozzle encapsulation method: Core-shell encapsulation or matrix-encapsulation of graphene sheets and P particles can be conducted using a laminar flow through a nozzle and vibration of the nozzle or the liquid. The vibration has to be done in resonance with the Rayleigh instability, leading to very uniform droplets. The liquid can consist of any liquids with limited viscosities (1-50,000 mPa·s): emulsions, suspensions or slurry containing the anode active material P particles and the graphene sheets dispersed in a liquid medium.

Spray-drying: Spray drying may be used to encapsulate graphene sheets and P particles (or P-decorated graphene sheets) when the graphene sheets and P particles (or P-decorated graphene sheets) are suspended in a polymer solution to form a suspension. In spray drying, the liquid feed (solution or suspension) is atomized to form droplets which, upon contacts with hot gas, allow solvent to get vaporized and a graphene-based shell to fully embrace the internal graphene sheets and P particles.

In-situ polymerization: In some micro-encapsulation processes, graphene sheets and P particles are fully coated with a graphene sheet-containing monomer or oligomer first. Then, direct polymerization of the monomer or oligomer is carried out on the surfaces of these material particles.

The following examples serve to provide the best modes of practice for the present disclosure and should not be construed as limiting the scope of the disclosure:

### Example 1: Production of PEDOT:PSS/Graphene-Encapsulated P-Decorated Graphene Sheets for Use as an Anode Material for Sodium-Ion Cells

Poly(3,4-ethylenedioxythiophene):polystyrene sulfonate (PEDOT:PSS) is a polymer mixture of two ionomers. One component is made up of sodium polystyrene sulfonate, which is a sulfonated polystyrene. Part of the sulfonyl groups are deprotonated and carry a negative charge. The other component poly(3,4-ethylenedioxythiophene) or PEDOT is a conjugated polymer, polythiophene, which carries positive charges. Together the two charged polymers form a macromolecular salt. The PEDOT/PSS is soluble in water.

Primary particles of an anode active material (e.g. red phosphorus particles 200 nm in diameter) and slightly reduced graphene oxide sheets (available from Taiwan Graphene Co.) were then dispersed in a PEDOT/PSS-water solution to form a slurry (2-8% by wt. solid content), which was spray-dried to form multiple particulate featuring a core shell structure wherein the shell is composed of multiple graphene sheets bonded by PEDOT/PSS and the core is composed of internal graphene sheets, red phosphorus particles, and 30-65% by volume of pores. The resulting particulate powder mass is herein referred to as Sample 1A.

An amount of Sample 1A was subjected to sublimation at 450° C. for 20 minutes and cooled naturally (sublimation point of red phosphorus is 416-590° C.) to vaporize P and re-dispersed P in thin coating form (30-55 nm thick) bonded to surfaces of internal graphene sheets. The resulting powder mass sample is herein referred to as Sample 1B. The active material (P) content in the particulates of both Sample 1A and 1B are approximately 81%.

A baseline sample of powder mass, Sample 1C, comprising phosphorus/carbon (P/C) composite particles enclosed by reduced graphene oxide sheets, was prepared by following a procedure proposed by G. H. Lee, et al. [Ref.6]. In a representative procedure, P/C composite nanoparticles were synthesized by a high energy mechanical milling method. Red phosphorus and Super P (a popular conductive additive used in a lithium-ion battery electrode) at a molar ratio C/P=1/1 was ball-milled for 48 hours in an inert atmosphere. After milling, the resulting black powder was rinsed with CS₂ and dried in a vacuum oven. Subsequently, 0.5 mg of GO sheets and 0.20 g of the P/C composite was dispersed in 100 mL of deionized water. The suspension was subjected to sonication and vigorous stirring and then spray-dried to obtain particulate powder. After spray-drying, GO-coated P/C composite powder was soaked in 0.01 M of Cu(NO₃)₂ solution and reduced with 0.10 g of NaBH₄. The resulting composite particulates have an active material (P) content of approximately 22% by weight.

These three types of anode active materials were incorporated as an anode active material in sodium-ion batteries. Electrochemical characterization was conducted by using CR2032-type coin cell wherein Na metal was used as the counter and reference electrodes. To make slurry, active material (70 wt %), Super P (10 wt %) and PAA binder (20 wt %) were mixed in mortal and then N-methyl-2-pyrrolidone (NMP) was added to regulate the viscosity of slurry. The slurry was casted on Cu foil and dried in a vacuum oven at 150° C. for 10 h. Disc-shape electrodes were punched into 12 mm size. The average loading mass of electrodes was 1.1 mg/cm². Also, 1 M solution of NaPF6 in ethylene carbonate (EC) and diethyl carbonate (DEC) (1:1, v/v) with 5% flouro-ethylene carbonate (FEC) was employed as an electrolyte, and glass fiber fabric was used as a porous separator. The coin cell was fabricated in an Ar-filled glove box. Galvanostatic charge-discharge cycling test was performed between 0.01 and 2 V vs. Na⁺/Na at various rates or current densities (0.1 to 2 A/g).

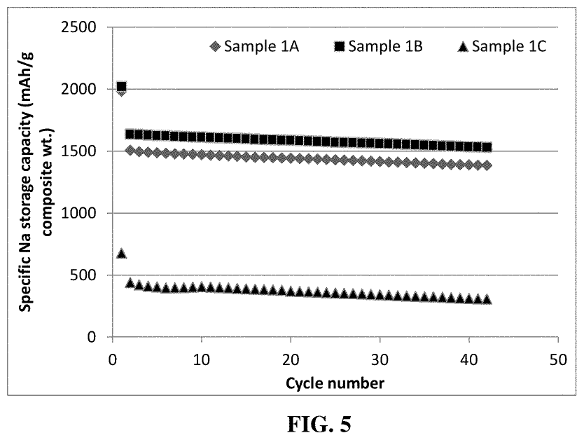

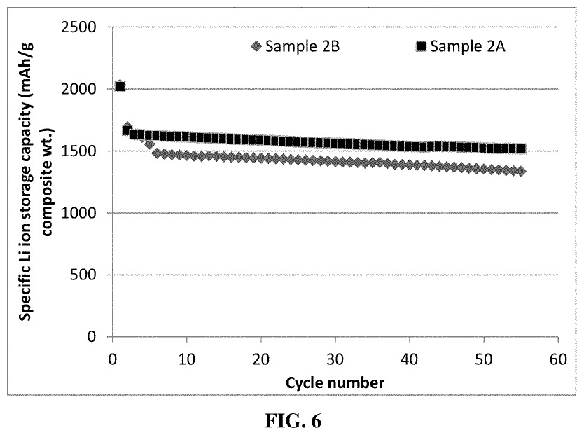

Shown in FIG. 5 are three specific capacity curves (mAh/g-composite) of Samples 1A, 1B and 1C, respectively. These data indicate that Sample 1B (with an additional step of vaporizing phosphorus and redepositing it in thin coating form on surfaces of internal graphene sheets) delivers the highest specific capacity (2022 mAh/g-composite; based on the total composite weight, not just P weight), highest first-cycle Coulomb efficiency (unprecedented 81%), and most stable cycling behavior. Sample 1A also shows exceptional specific capacity (1982 mAh/g-composite), first-cycle efficiency (76%, excellent value for P-based anode material), and relatively stable cycling behavior. Sample 1C, graphene-coated carbon/P composite particulates, exhibit the poorest electrochemical responses.

It may be noted that the specific sodium ion storage capacity values in FIG. 5 are calculated based on the total anode electrode weight (excluding anode current collector and resin binder), not just the phosphorus weight. As opposed to the specific capacity value (mAh/g-phosphorus) calculated based on the phosphorus weight alone, as done in most of the scientific articles [e.g. Ref. 6], the specific capacity based on the total composite weight is significantly more meaningful, particularly when it comes to the calculation of the actual cell specific energy density (Wh/kg). For instance, even though Lee, et al. [Ref. 6] reported a specific capacity as high as 2,250 mAh/g-p (based on the weight of P alone), the P content in the anode structure is only 23.1% and, as such, the actual specific capacity of Lee's anode is 2250×0.231=520 mAh/g-composite. In the entire anode electrode, only 23.1% of the materials used are capable of storing Na ions.

### Example 2: Conductive Polymer/Graphene Shell Encapsulated Core of Red Phosphorus Particles and Internal Graphene Sheets

The process of example 1 was replicated with PEDOT/PSS being replaced by Polypyrrole (PPy) and RGOs replaced by pristine graphene sheets obtained by the well-known direct ultrasonication or liquid phase exfoliation procedure. Polypyrrole soluble in chloroform and m-cresol was chemically synthesized by using ammonium persulfate as an oxidant and dodecylbenzene sulfonic acid as a dopant source. The red phosphorus primary particles were dispersed in a Polypyrrole/chloroform solution, along with pristine graphene sheets, to form a suspension, which was spray-dried to form core-shell particulates wherein the encapsulating shell is composed of graphene sheets bonded by PPy and the core comprises internal pristine graphene sheets and red phosphorus particles that are bonded to surfaces of internal graphene sheets via PPy. This powder mass is herein designated as Sample 2A.

On a separate basis, some amount from the same batch of pristine graphene sheets was dispersed in water containing a surfactant to assist in the formation of a homogeneous suspension. A desired amount of red phosphorus primary particles was then added into this suspension to form a multi-component slurry. The slurry was then spray-dried to form core-shell particulates wherein the encapsulating shell is composed of overlapped graphene sheets and the core comprises internal pristine graphene sheets and red phosphorus particles that are in physical contact with surfaces of internal graphene sheets. The powder mass produced is herein designated as Sample 2B.

Powder particulates from both Sample 2A and Sample 2B were made into electrodes of lithium-ion batteries according to a procedure described in Example 4 below. FIG. 6 shows two specific lithium ion storage capacity curves (mAh/g-composite) of two anode active core-shell particulates. Sample 2A and Sample 2B exhibit similar initial specific lithium ion storage capacity. However, after a few cycles, Sample 2A deliver better electrochemical responses. In Sample 2A, the encapsulating shell is composed of graphene sheets bonded by PPy and the core comprises internal pristine graphene sheets and red phosphorus particles that are bonded to surfaces of internal graphene sheets via PPy. In Sample 2B, the encapsulating shell is composed of overlapped graphene sheets and the core comprises internal pristine graphene sheets and red phosphorus particles that are in physical contact with surfaces of internal graphene. It appears that the presence of a conducting polymer in the encapsulating shell helps to seal off the gaps in the shell, thereby preventing direct contact of liquid electrolyte with P that would otherwise induce repeated formation and destruction of SEI or other undesirable side reactions when the battery is charged and discharged.

### Example 3: Preparation of Graphene Fluoride-Black Phosphorus Platelet Particulates

This task began with preparation of graphene fluoride (GF) sheets. In a typical procedure, a powder mass of graphene particulates prepared in Example 1 was fluorinated by vapors of chlorine trifluoride in a sealed autoclave reactor to yield fluorinated graphene hybrid particulates. Different durations of fluorination time were allowed for achieving different degrees of fluorination.

On a separate basis, black phosphorus crystals were prepared from red phosphorus. In a representative procedure, red phosphorus (900 mg), AuSn alloy (360 mg), and SnI₄ (18 mg) were first sealed in a quartz ampoule (13 cm in length and 15 mm in diameter) that was evacuated to a pressure lower than 10⁻³ mbar. The sealed ampoule was then placed horizontally in the reaction zone of a tube furnace and heated to 650° C. in 1 h. After exposure to 650° C. for 24 h, the ampoule was cooled to 500° C. at a rate of 30° C./h, and then cooled to room temperature after being held at 500° C. for 30 min. This procedure led to the formation of large BP crystals (about 850 mg) on the cold end of the ampoule. The BP crystals were recovered and washed with toluene to remove the residual mineralizer, followed by water and acetone rinsing.

The liquid phase exfoliation method was then used to exfoliate BP crystals into mono-layer and few-layer BP platelets. This procedure began with grinding the BP crystals to fine powder particles, which were dispersed in deionized water (20 mL) with an initial concentration of 5 mg/mL by tip sonication for 2 hours. After the dispersion had settled for 12 h, the supernatant was decanted and then centrifuged at 1500-5000 rpm for 30 min. Finally, the resulting BP nano-sheet dispersion (supernatant) was collected and mixed with graphene fluoride-water suspension (containing some surfactant) for subsequent spray-drying into core-shell particulates.

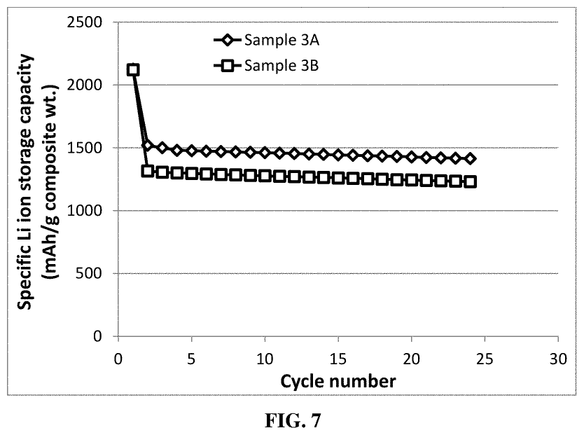

The resulting particulates comprising graphene fluoride (GF)-encapsulated core of phosphorene/GF sheets were made into anode electrodes by following the procedure described in Example 4. This is herein referred to as Sample 3A. Separately, BP nano-sheet dispersion mixed with graphene fluoride-water suspension was made into phosphorene/GF composite paper using a vacuum-assisted filtration process. Such a paper-like structure was used directly as an anode electrode, herein referred to as Sample 3B. The specific capacity values of the two anodes, using a Li metal disc as a counter electrode, are shown in FIG. 7. These data indicate the superior electrochemical performance of the graphene-enabled core-shell anode materials as compared to the paper-like structure.

### Example 4: Preparation and Electrochemical Testing of Various Battery Cells

For most of the anode active materials investigated, we prepared lithium cells using the conventional slurry coating method. A typical anode composition includes 85 wt. % active material (e.g., the presently disclosed core-shell particulates), 7 wt. % acetylene black (Super-P), and 8 wt. % polyvinylidene fluoride binder (PVDF, 5 wt. % solid content) dissolved in N-methyl-2-pyrrolidinoe (NMP). After coating the slurries on Cu foil, the electrodes were dried at 120° C. in vacuum for 2 h to remove the solvent. Lithium metal disc was used as a counter-electrode. The electrolyte contains 1 M LiPF₆ dissolved in a mixture of ethylene carbonate (EC) and diethyl carbonate (DEC) (EC-DEC, 1:1 v/v). An anode layer, separator layer (e.g. Celgard 2400 membrane), and a lithium disc were then laminated together and housed in a coin-cell configuration. The cell assemblies were made in an argon-filled glove-box.

The cyclic voltammetry (CV) measurements were carried out using an Arbin electrochemical workstation at a typical scanning rate of 1 mV/s. In addition, the electrochemical performances of various cells were also evaluated by galvanostatic charge/discharge cycling at a current density of typically from 50 mA/g to 10 A/g. For long-term cycling tests, multi-channel battery testers manufactured by LAND were used.

In lithium-ion battery industry, it is a common practice to define the cycle life of a battery as the number of charge-discharge cycles that the battery suffers 20% decay in capacity based on the initial capacity measured after the required electrochemical formation. We have made the following observations:
(a) In general, we have observed that graphene encapsulation imparts a significantly higher cycle life to a lithium-ion battery or sodium-ion battery featuring a high-capacity phosphorus-based anode active material. The implementation of internal graphene sheets inside the core to support nano particles or coating of a phosphorus material also significantly enhances the cycling stability of the battery
(b) An electron-conducting polymer may be used to bond the graphene sheets in the encapsulating shell, helping to seal off the encapsulating shell.
(c) Pores inside the core of the particulate also lead to more stable cycling behaviors.

1. A graphene-encapsulated phosphorus anode particulate for a lithium battery or sodium ion battery, said particulate comprising:
A) a core comprising a phosphorus material and one or a plurality of internal graphene sheets, wherein said internal graphene sheets have a length or width from 5 nm to 100 μm and contain single-layer or few-layer graphene sheets and said phosphorus material is in a form of particles or coating in physical contact with the internal graphene sheets and having a diameter or thickness from 0.5 nm to 10 μm and is selected from red phosphorus, black phosphorus, violet phosphorus, a metal phosphide, MP_{y}, or a combination thereof, wherein M=Mn, V, Sn, Ni, Cu, Fe, Co, Zn, Ge, Se, Mo, Ga, In, or an alloy thereof, and y=from 1 to 4; and
B) an encapsulating shell that embraces or encapsulates said core, wherein said encapsulating shell comprises multiple graphene sheets and have a thickness from 0.34 nm to 5 μm.

2. The anode particulate of claim 1, wherein said phosphorus material is bonded to surfaces of said internal graphene sheets.

3. The anode particulate of claim 2, wherein said electron-conducting polymer contains a conjugated polymer selected from Polyacetylene, Polythiophene, Poly(3-alkylthiophenes), Polypyrrole, Polyaniline, Poly(isothianaphthene), Poly(3,4-ethylenedioxythiophene), alkoxy-substituted Poly(p-phenylene vinylene), Poly(2,5-bis(cholestanoxy) phenylene vinylene), Poly(p-phenylene vinylene), Poly(2,5-dialkoxy) paraphenylene vinylene, Poly[(1,4-phenylene-1,2-diphenylvinylene)], Poly(3′,7′-dimethyloctyloxy phenylene vinylene), Polyparaphenylene, Polyparaphenylene, Polyparaphenylene sulphide, Polyheptadiyne, Poly(3-hexylthiophene), Poly(3-octylthiophene), Poly(3-cyclohexylthiophene), Poly(3-methyl-4-cyclohexylthiophene), Poly(2,5-dialkoxy-1,4-phenyleneethynylene), Poly(2-decyloxy-1,4-phenylene), Poly(9,9-dioctylfluorene), Polyquinoline, a derivative thereof, a copolymer thereof, or a combination thereof.

4. The anode particulate of claim 2, wherein said electron-conducting polymer partially or fully covers or encapsulates said phosphorus material.

5. The anode particulate of claim 1, wherein said encapsulating shell comprises an ion-conducting or electron-conducting material that bonds said multiple graphene sheets together to prevent a direct contact of said phosphorus material with a liquid electrolyte in said lithium-ion battery or sodium-ion battery.

6. The anode particulate of claim 1, wherein graphene sheets in said core or said encapsulating shell contain single-layer or few-layer graphene, wherein said few-layer graphene sheets have 2-10 layers of stacked graphene planes having an inter-plane spacing d₀₀₂ from 0.3354 nm to 0.6 nm as measured by X-ray diffraction and said single-layer or few-layer graphene sheets contain a pristine graphene material having essentially zero % of non-carbon elements, or a non-pristine graphene material having 0.001% to 25% by weight of non-carbon elements.

7. The anode particulate of claim 6, wherein said non-pristine graphene is selected from graphene oxide, reduced graphene oxide, graphene fluoride, graphene chloride, graphene bromide, graphene iodide, hydrogenated graphene, nitrogenated graphene, doped graphene, chemically functionalized graphene, or a combination thereof.

8. The anode particulate of claim 1, wherein said core further comprises a single pore or a plurality of pores to accommodate a volume expansion of said phosphorus material when said lithium-ion battery or sodium-ion battery is charged.

9. The anode particulate of claim 8, wherein said phosphorus material inside said core has a volume V₁ and said pore or pores have a total volume V₂, wherein the V₂/V₁ ratio is from 0.5 to 3.5.

10. The anode particulate of claim 1, wherein said core further comprises an electron-conducting material selected from a carbon, pitch, carbonized resin, conductive polymer, conductive organic material, metal, metal oxide, expanded graphite, or a combination thereof.

11. The anode particulate of claim 1, wherein said core further comprises a lithium or sodium ion-conducting material.

12. The anode particulate of claim 11, wherein said lithium or sodium ion-conducting material is selected from amorphous carbon, an ion-conducting polymer, an ion-conducting polymer gel, an inorganic solid electrolyte, or a combination thereof.

13. The anode particulate of claim 12, wherein said ion-conducting polymer comprises a polymer selected from poly(ethylene oxide), polypropylene oxide, poly(ethylene glycol), poly(acrylonitrile), poly(methyl methacrylate), poly(vinylidene fluoride), poly bis-methoxy ethoxyethoxide-phosphazene, polyvinyl chloride, polydimethylsiloxane, poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer electrolyte with a carboxylate anion, a sulfonylimide anion, or sulfonate anion, a crosslinked electrolyte of poly(ethylene glycol) diacrylate or poly(ethylene glycol) methyl ether acrylate, a sulfonated derivative thereof, or a combination thereof.

14. The anode particulate of claim 1, wherein said phosphorous material particles are porous having surface pores, internal pores, or both surface and internal pores.

15. The anode particulate of claim 1, wherein said phosphorus material particles include nano particles selected from flakes, beads, pellets, spheres, wires, fibers, filaments, discs, ribbons, or rods, having a diameter or thickness from 1 nm to 100 nm or wherein said phosphorus material coating deposited on surfaces of internal graphene sheets have a thickness from 0.5 nm to 100 nm.

16. The anode particulate of claim 1, wherein said phosphorus material particles comprise phosphorene, which contains mono-layer or few-layer 2D platelets of black phosphorus.

17. A powder mass comprising multiple anode particulates as defined in claim 1.

18. An anode electrode comprising multiple anode particulates as defined in claim 1 as an anode material.

19. A lithium-ion battery comprising the anode of claim 17, a cathode, and an electrolyte.

20. A sodium-ion battery comprising the anode of claim 17, a cathode, and an electrolyte.

21. A process for producing multiple anode particulates as defined in claim 1, wherein the process comprises:
(A) combining particles of the phosphorus material, multiple graphene sheets, optional particles of a carbon material, and a liquid medium to form a suspension; and
(B) forming and drying the suspension into secondary particles or particulates wherein the particulate comprises a core-shell structure having a core of particles of the phosphorus material, internal graphene sheets, optional particles of a carbon material, and pores and a shell comprising multiple (external) graphene sheets embracing the core.

22. The process of claim 21, further comprising thermally vaporizing the phosphorus material and re-distributing the phosphorus material vapor in the core, making the vapor to deposit as a coating or nano particles of the phosphorus material supported on surfaces of the internal graphene sheets.

23. The process of claim 21, wherein step (A) of combining comprises a procedure of depositing phosphorus material onto graphene surfaces to produce phosphorus material-decorated graphene sheets, containing phosphorus particles or coating, phosphorene platelets, or metal phosphide particles or coating bonded on graphene surfaces.

24. The process of claim 23, wherein the procedure of depositing phosphorus material onto graphene surfaces comprises physical vapor deposition, chemical vapor deposition, sputtering, plasma-enhanced deposition, solution phase deposition, chemical deposition, electrochemical deposition, thermal spraying, ultrasonic spraying, electrostatic deposition, electrophoretic deposition, laser ablation deposition, or a combination thereof.

25. The process of claim 21, wherein step (B) is followed by a procedure of incorporating a carbon material or a conducting polymer onto or into the encapsulating shell to bridge a gap between two graphene sheets or to seal off the encapsulating shell.

26. The process of claim 25, wherein the conducting polymer contains an electron-conducting or conjugated polymer selected from Polyacetylene, Polythiophene, Poly(3-alkylthiophenes), Polypyrrole, Polyaniline, Poly(isothianaphthene), Poly(3,4-ethylenedioxythiophene), alkoxy-substituted Poly(p-phenylene vinylene), Poly(2,5-bis(cholestanoxy) phenylene vinylene), Poly(p-phenylene vinylene), Poly(2,5-dialkoxy) paraphenylene vinylene, Poly[(1,4-phenylene-1,2-diphenylvinylene)], Poly(3′,7′-dimethyloctyloxy phenylene vinylene), Polyparaphenylene, Polyparaphenylene, Polyparaphenylene sulphide, Polyheptadiyne, Poly(3-hexylthiophene), Poly(3-octylthiophene), Poly(3-cyclohexylthiophene), Poly(3-methyl-4-cyclohexylthiophene), Poly(2,5-dialkoxy-1,4-phenyleneethynylene), Poly(2-decyloxy-1,4-phenylene), Poly(9,9-dioctylfluorene), Polyquinoline, a derivative thereof, a copolymer thereof, or a combination thereof.

27. The process of claim 25, wherein the conducting polymer contains an ion-conducting polymer or a polymer gel electrolyte.

28. The process of claim 27, wherein the ion-conducting polymer or polymer gel electrolyte comprises a polymer selected from poly(ethylene oxide), polypropylene oxide, poly(ethylene glycol), poly(acrylonitrile), poly(methyl methacrylate), poly(vinylidene fluoride), poly bis-methoxy ethoxyethoxide-phosphazene, polyvinyl chloride, polydimethylsiloxane, poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer electrolyte with a carboxylate anion, a sulfonylimide anion, or sulfonate anion, a crosslinked electrolyte of poly(ethylene glycol) diacrylate or poly(ethylene glycol) methyl ether acrylate, a sulfonated derivative thereof, or a combination thereof.
